(19) United States
(12) Patent Application Publication
(10) Pub. No.: US 2014/0262287 A1
(43) Pub. Date: Sep. 18, 2014

(54) ENVIRONMENTALLY FRIENDLY QUATERNARY SALTS OF AMINES AND THEIR USE AS TEMPORARY AND/OR PERMANENT CLAY STABILIZERS AND METHODS FOR MAKING AND USING SAME

(71) Applicant: CLEARWATER INTERNATIONAL, LLC, Houston, TX (US)

(72) Inventors: Duane S. Treybig, Houston, TX (US); Alan Russell, Houston, TX (US); Aziz Hikem, Houston, TX (US)

(21) Appl. No.: 14/211,025

(22) Filed: Mar. 14, 2014

Related U.S. Application Data
(60) Provisional application No. 61/790,299, filed on Mar. 15, 2013.

(51) Int. Cl. C09K 8/035

(52) U.S. Cl. CPC C09K 8/035
USPC 166/305.1; 507/131; 507/133

(57) ABSTRACT

New classes of temporary and/or permanent clay stabilization compositions including at least one quaternary salt of primary amines, secondary amines, tertiary amines, reaction products of these amines with at least one aldehyde, or mixtures and combinations thereof and to methods for making and using same, where the quaternary salts have reduced toxicity.

### RELATED APPLICATIONS

This application claims the benefit of and priority to U.S. Provisional Patent Application Ser. No. 61/790,299 filed Mar. 15, 2013 (15 Mar. 2013). This application is also related to U.S. patent Ser. No. 14/211,066, filed 03132014 (13 Mar. 2014).

### BACKGROUND OF THE INVENTION

1. Field of the Invention

Embodiments of the present invention relate to new classes of temporary and permanent clay stabilization compositions and to methods for making and using same.

More particularly, embodiment of the present invention relate to new classes of temporary and permanent clay stabilization compositions, where the compositions includes one or a plurality of quaternary salts of primary, secondary, tertiary amines, mono, di and tri alkanol amines, mono, di, tri alkyleneether amines, or mixtures and combinations thereof. The invention also related to methods for making and using same.

2. Description of the Related Art

Clay stabilizer is a chemical additive used in stimulation treatments to prevent the migration or swelling of clay particles in reaction to water-base fluid. There are two types of clay stabilizers, temporary and permanent. There is a need for more environmentally friendly clay stabilizers and a need for more permanent clay stabilizers, especially those that are environmentally friendly.

During drilling and/or completion, zones that comprise shales and/or reactive clays can become unstable, when they are in contact with water in a drilling fluid. These zones contain clays that have been dehydrated over geologic time by overburden pressure. When these zone are exposed to a water containing material such as a drilling fluid, the clays osmotically imbibe water from the drilling fluid and swell. The swelling of the shale induces stresses, loss of mechanical strength, and shale failure. See Thomas W. Beihoffer et al in the May 16, 1992 Oil & Gas Journal, page 47 et seq., entitled “Cationic Polymer Drilling Fluid Can Sometimes Replace Oil-based Mud” for a more in depth explanation of the problem of drilling through clay containing zones. Shale crumbling into the borehole (“sloughing”) can ultimately place a burden on the drill bit which makes it impossible to retrieve.

Salts such as potassium chloride have been widely used in drilling treatments to convert the formation material from the sodium form by ion exchange to, for example, the potassium form which is less vulnerable to swelling; also the use of high concentrations of potassium salts affects the osmotic balance and tends to inhibit the flow of water away from the high potassium salt concentration fluids into the shale. However, it is difficult to maintain the required high concentrations of potassium salts in the drilling fluids. In addition, the physical introduction of such salts causes difficulties with the use of the viscosifying materials typically used for drilling. Inorganic salts can also have a harmful effect on the environment if released.

There are three general types of amine and/or quaternary ammonium cation sources which have been suggested for clay treatment during drilling operations and hydrocarbon recovery. The three types include: (a) compounds having a single-site quaternary ammonium cation and amine, (b) compounds having a few (two to about six) amine or quaternary ammonium cation sites, sometimes referred herein as “oligo-cationics”, and (c) quaternary ammonium or amine polymers, which may have from about six to thousands of cationic sites. Such prior art clay control compounds are disclosed in U.S. Pat. Nos. 2,761,835; 2,761,840; 2,761,836; 4,842,073; 5,211,239; 2,761,843; 3,349,032; 4,447,342; 4,374,739; 4,366,071 and 6,921,742, incorporated herein by reference.

Although there are numerous examples of clay control additives, there is still a need in the art for new clay control additives, especially environmentally friendly clay control additives.

### SUMMARY OF THE INVENTION

Embodiments of the present invention provide clay stabilizing compositions of this invention include one or more quaternary salts of primary, secondary, tertiary amines, mono, di and tri alkanol amines, mono, di, tri alkyleneether amines, or mixtures and combinations thereof.

Embodiments of the present invention provide clay stabilizing compositions of this invention include at least one quaternary salt compounds of Formula (I) and/or a reaction product of compounds of Formula (I) with at least one aldehyde:

[R¹R²R³N(R⁰)ⱼ]⁺A⁻ (I)

where:
A and R⁰ are derived from the general formula R⁰A selected from the formulas consisting of R^{I}R^{II}SO₄, R^{I}SO₃H, R^{III}Cl, ArCl, ArR^{IV}Cl, R^{V}O(R^{VI}O)R^{VI}Cl, ClR^{VI}O(R^{VI}O)R^{VI}Cl, or mixtures and combinations thereof, where R^{I}, R^{II}, R^{III}, and Rv are the same or different carbyl groups, Ar is an aryl group, and R^{IV} and R^{VI} are the same or different linking carbyl groups, where R⁰ is selected from the group consisting of a hydrogen atom (H), R^{I} or R^{II}, R^{III}, Ar, ArR^{IV}, R^{V}O(R^{VI}O)R^{VII}, ClR^{VI}O(R^{VI}O)R^{VI}, R^{VI}O(R^{VI}O)R^{VI}, and mixtures thereof and A⁻ is selected from the group consisting of R^{I}SO₄⁻ or R^{II}SO₄⁻, R^{I}SO₃⁻, Cl⁻, [R^{VI}O(R^{VI}O)R^{VI}Cl]⁻, [R^{VI}O(R^{VI}O)R^{VI}]²⁻, and mixtures thereof, R¹, R², and R³ are the same or different and are either a hydrogen atom (H), a linear, branched or cyclic carbyl group having between 1 and 20 carbon atoms, an R^{a}OH group, an R^{a}(OR^{aa})ₙOH group, an R^{a}OR group, an R^{a}(OR^{aa})ₙOR′ group, or mixtures and combinations thereof, provided at least one of the R¹, R², and R³ groups is not a hydrogen atom,
j is an integer having a value between 1 and the maximum number of NH moieties plus 1,
R^{a} and R^{aa} are the same or different linear or branched carbyl linking groups having between 1 and 20 carbon atoms, and
R and R′ are linear, branched or cyclic carbyl group having between 1 and 20 carbon atoms.

Embodiments of the present invention provide drilling fluids including an effective amount of at least one clay stabilizing composition of this invention. Embodiments of the present invention provide completion fluids including an effective amount of at least one clay stabilizing composition of this invention. Embodiments of the present invention provide fracturing fluids including an effective amount of at least one clay stabilizing composition of this invention.

Embodiments of the present invention provide methods for making compounds of this invention. Embodiments of the present invention provide methods for drilling using a drilling fluid including at least one clay stabilizing composition of this invention. Embodiments of the present invention provide methods for completing using a completion fluid including at least one clay stabilizing composition of this invention. Embodiments of the present invention provide methods for fracturing using a fracturing fluid including at least one clay stabilizing composition of this invention.

### BRIEF DESCRIPTION OF THE DRAWINGS

The invention can be better understood with reference to the following detailed description together with the appended illustrative drawings in which like elements are numbered the same:

FIG. 1A-C depict structures of exemplary of compounds of Formulas (I-III).

FIG. 2 depicts water release data for 71.7 wt. % choline chloride available as Bio Add 1200 from Shrieve Chemical Company from Weatherford Wyoming Bentonite.

FIG. 3 depicts water release data for 40.3 wt. % choline chloride available as Bio Add 1200 from Shrieve Chemical Company from Weatherford Wyoming Bentonite.

FIG. 4 depicts water release data for XC-197 in the range of 1.5 wt. % to 3 wt. %. XC-197 is a clay control additive available from Pchem, A Weatherford Company. The plot shows the behavior of XC-197 for 1 wt. % Charles B. Chrystle Co. clay versus 1 wt. % Weatherford Wyoming Bentonite.

FIG. 5 depicts water release data for XC-197 in the range between 2 gpt and 10 gpt. XC-197 is a clay control additive available from Pchem, A Weatherford Company. The plot shows the behavior of XC-197 for 1 wt. % Weatherford Wyoming Bentonite.

FIG. 6 depicts components of Huntsman Amine C9 including their chemical names and structures used in the preparation of the quaternary salts of Example 1 and Example 2.

FIG. 7 depicts chemical structures of diethyl sulfate quaternary salts of Huntsman C9 amine as set forth in Example 1.

FIG. 8 depicts water release data for the quaternary salts of Example 1 from Weatherford Wyoming Bentonite.

FIG. 9 depicts chemical structures of dimethyl sulfate quaternary salts of Huntsman C9 amine as set forth in Example 2.

FIG. 10 depicts water release data for the quaternary salts of Example 2 from Weatherford Wyoming Bentonite.

FIG. 11 depicts water release data for the quaternary salts of Examples 1 and Example 2 from Cream Bentonite from Charles B. Chrystle.

FIG. 12 depicts chemical structures of possible reaction products of the reaction of diethanolamine and formaldehyde as described in Example 3.

FIG. 13 depicts chemical structures of possible diethyl sulfate quaternary salts of the reaction products of Example 3.

FIG. 14 depicts water release data for the quaternary salts of Example 3 from Weatherford Wyoming Bentonite.

FIG. 15 depicts chemical structure of a possible benzyl chloride quaternary salt of triethanol amine of Example 4.

FIG. 16 depicts water release data for the quaternary salt of Example 4 from Weatherford Wyoming Bentonite.

FIG. 17 depicts chemical structure of a possible diethyl sulfate quaternary salt of the triethanol amine of Example 5.

FIG. 18 depicts water release data for the quaternary salt of Example 5 from Weatherford Wyoming Bentonite.

FIG. 19 depicts chemical structures of possible reaction products of aminoethylethanolamine (AEEA) and two moles of formaldehyde of Examples 11-13.

FIG. 20 depicts benzyl chloride, diethyl sulfate, and dichloroethylether quaternary salts of a possible amine formed in reaction mixture of Examples 11, 12, and 13.

FIG. 21 depicts water release data for the dichloroethylether quaternary salt of Example 11 from Weatherford Wyoming Bentonite.

FIG. 22 depicts water release data for the dichloroethylether quaternary salt of Example 11 from Weatherford Wyoming Bentonite

FIG. 23 depicts water release data for the benzyl chloride quaternary salt of Example 12 from Weatherford Wyoming Bentonite.

FIG. 24 depicts water release data for the diethyl sulfate quaternary salt of Example 13 from Cream Bentonite (Charles B. Chrystle Co, Inc.).

FIG. 25 depicts water release data for the diethyl sulfate quaternary salt of Example 14 from Weatherford Wyoming Bentonite.

FIG. 26 depicts possible chemical structures of the reaction product of aminoethylethanolamine (AEEA) and two moles of formaldehyde formed in Example 15.

FIG. 27 depicts possible chemical structures of benzyl chloride, diethyl sulfate, and dichloroethylether quaternary salts of the possible amines formed in Example 15.

FIG. 28 depicts water release data for the dichloroethylether quaternary salt of Example 15 from Weatherford Wyoming Bentonite.

### DETAILED DESCRIPTION OF THE INVENTION

The inventors have found that new quaternary clay stabilizing compositions including one or a plurality of a new class of quaternary salt clay stabilization additives that have reduced toxicity and equivalent water release properties as conventional clay stabilization compounds. The inventors have found that one such new class of quaternary salt clay stabilization additives includes one or more quaternary salts of primary, secondary, tertiary amines, mono-, di-, and tri-alkanol amines, mono-, di-, tri-alkyleneether amines, or mixtures and combinations thereof. The inventors have also found that one such new class of quaternary salt clay stabilization additives includes one or more quaternary salts of a reaction product of primary amines, secondary amines, monoalkanol amines, dialkanol amines, monoalkyleneether amines, dialkyleneether amines, or mixtures and combinations thereof with an aldehyde or an aldehyde donor. The inventors have also found that the quaternary salts of compounds of Formula (I), Formula (II), and/or Formula (III) represent new quaternary salt clay stabilizing compounds. We have also found that some of these new quaternary salt clay stabilizing compounds have reduced adverse environmental effects compared to conventional quaternary salt clay stabilizing compounds. We have found that the new quaternary clay stabilizing compounds are effective both as temporary and permanent clay stabilizers, are effective clay stabilizers with reduced corrosion propensity for downhole and surface equipment such as piping, casing, pumps, etc. and many of the compounds have improved environmental properties including reduced toxicity to microorganisms and vertebrates. We have also found that the compounds may be tailored by selecting the amines and the quaternarizing agents needed to render them more environmentally friendly and less toxic.

Embodiments of the present invention also broadly relates to drilling fluids including an effective amount of at least one clay stabilizing composition of this invention.

Embodiments of the present invention also broadly relates to completion fluids including an effective amount of at least one clay stabilizing composition of this invention.

Embodiments of the present invention also broadly relates to fracturing fluids including an effective amount of at least one clay stabilizing composition of this invention.

Embodiments of the present invention also broadly relates to methods for making compounds of the Formula (I), Formula (II), and/or Formula (III).

Embodiments of the present invention also broadly relates to methods for drilling using a drilling fluid including at least one clay stabilizing composition of this invention.

Embodiments of the present invention also broadly relates to methods for completing using a completion fluid including at least one clay stabilizing composition of this invention.

Embodiments of the present invention also broadly relates to methods for fracturing using a fracturing fluid including at least one clay stabilizing composition of this invention.

In certain embodiments of this invention, the compounds of this invention may also include morpholine amine corrosion inhibitors such as C6 amine available from Huntsman Corporation in the final stages of preparation so that the morpholine amines impart improved anti-corrosion characteristics to the formulation. The inventors have found that by adding C6 amine to the reaction mixtures during preparation, the morpholine amines imparted needed anti-corrosion characteristics to the compositions. The inventors believe that the new compounds are well suited as clay stabilizers, corrosion inhibitors, scale inhibitors, de-emulsifiers, and/or collectors in ore floatation and other oil field and mining applications. These compositions are particularly useful as clay stabilizers that are environmentally friendly.

Embodiments of the present invention provide clay stabilizing compositions of this invention include one or more quaternary salts of compounds of Formula (II):

[chemical structure]

where:
A and R⁰ are derived from the general formula R⁰A selected from the formulas consisting of R^{I}R^{II}SO₄, R^{I}SO₃H, R^{III}CL, ArCl, ArR^{IV}Cl, R^{V}O(R^{VI}O)R^{VI}Cl, ClR^{VI}O(R^{VI}O)R^{VI}Cl, or mixtures and combinations thereof, where H, R^{I}, R^{II}, R^{III}, and R^{V} are the same or different carbyl groups, Ar is an aryl group, and R^{IV} and R^{VI} are the same or different linking carbyl groups, where R⁰ is selected from the group consisting of a hydrogen atom (H), R^{I} or R^{II}, R^{III}, Ar, ArR^{IV}, R^{V}O(R^{VI}O)R^{VII}, clR^{VI}O(R^{VI}O)R^{VI}, R^{VI}O(R^{VI}O)R^{VI}, and mixtures thereof and A⁻ is selected from the group consisting of R^{I}SO₄⁻ or R^{II}SO₄⁻, R^{I}SO₃⁻, Cl⁻, [R^{VI}O(R^{VI}O)R^{VI}Cl]⁻, and mixtures thereof,
R¹, R², and R³ are the same or different and are either a hydrogen atom (H), a linear, branched, or cyclic carbyl group having between 1 and 20 carbon atoms, an R^{a}OH group, an R^{a}(OR^{aa})ₙOH group, an R^{a}OR group, an R^{a}(OR^{aa})ₙOR′ group, or mixtures and combinations thereof, provided at least one of the R′, R², and R³ groups is not a hydrogen atom,
j is an integer having a value between 1 and the maximum number of NH moieties plus 1, Ra and Raa are the same or different linear or branched carbyl linking groups having between 1 and 20 carbon atoms, and
R and R′ are linear, branched or cyclic carbyl group having between 1 and 20 carbon atoms.

Embodiments of the present invention provide clay stabilizing compositions of this invention include one or more quaternary salts of a reaction product of primary amines, secondary amines, monoalkanol amines, dialkanol amines, monoalkyleneether amines, dialkyleneether amines, or mixtures and combinations thereof with an aldehyde or an aldehyde donor.

Embodiments of the present invention provide clay stabilizing compositions of this invention include a reaction product of compounds of Formula (II) with at least one aldehyde to form quaternary salt compounds of Formula (III):

[chemical structure]

where:
A and R⁰ are as set forth above,
R¹, R², and R³ are the same or different and are independently either a hydrogen atom (H), a linear, branched or cyclic carbyl group having between 1 and 20 carbon atoms, an R^{a}OH group, an R^{a}(OR^{aa})ₙOH group, an R^{a}OR group, an R^{a}(OR^{aa})ₙOR′ group, or mixtures and combinations thereof, provided at least one of the R¹, R², and R³ groups is not a hydrogen atom,
j is an integer having a value between 1 and the maximum number of NH moieties plus 1,
R^{a} and R^{aa} are the same or different linear or branched carbyl linking groups having between 1 and 20 carbon atoms,
R and R′ are the same or different linear, branched or cyclic carbyl groups having between 1 and 20 carbon atoms,
R⁴ is a hydrogen atom (H), a linear, branched or cyclic carbyl group having between 1 and 20 carbon atoms and are derived from an aldehyde having the structure R⁴CHO, and
i is an integer having a value between 1 and 2.

FIGS. 1A-C show illustrative examples of compounds of Formula (I), Formula (II), and Formula (III) and reaction products of compounds of Formula (I) having NH moieties with aldehydes.

The quaternary salts of this invention are prepared by reacting monoamino compounds or reaction products of monoamino compounds having at least one NH moiety with one aldehyde or plurality of aldehydes with an effective amount of at least one alkylating agent R⁰A sufficient to alkylate any NH moiety or all remaining NH moieties and converting at least 40% of the tertiary amines present in the compounds into quaternary salts. In certain embodiments, the effective amount sufficient to alkylate any NH moiety or all remaining NH moieties and converting at least 50% of the tertiary amines present in the compounds into quaternary salts. In other embodiments, the effective amount sufficient to alkylate any NH moiety or all remaining NH moieties and converting at least 60% of the tertiary amines present in the compounds into quaternary salts. In other embodiments, the effective amount sufficient to alkylate any NH moiety or all remaining NH moieties and converting at least 70% of the tertiary amines present in the compounds into quaternary salts. In other embodiments, the effective amount sufficient to alkylate any NH moiety or all remaining NH moieties and converting at least 80% of the tertiary amines present in the compounds into quaternary salts. In other embodiments, the effective amount sufficient to alkylate any NH moiety or all remaining NH moieties and converting at least 90% of the tertiary amines present in the compounds into quaternary salts. In other embodiments, the effective amount sufficient to alkylate any NH moiety or all remaining NH moieties and converting at least 95% of the tertiary amines present in the compounds into quaternary salts.

For example, diethanolamine, a secondary amine, may be reacted with sufficient R⁰A to alkylate the diethanolamine to form R⁰-diethanolamine and then to convert 40 mole % of the resulting tertiary amines to R⁰,R⁰-diethanolammonium A salts.

In another example, diethanolamine, another secondary amine, may be reacted with an aldehyde to alkylate or dimerize the diethanolamine. The reaction product is then reacted with sufficient R⁰A to convert at least 40% of the tertiary amines present in the compounds into corresponding quaternary salts.

In certain embodiments, the quaternary salts of the amines of this invention and the quaternary salts of reaction products of amines and aldehydes may also include polyamines or mixtures of polyamines to augment the properties of the clay stabilization compositions of this invention.

### Suitable Reagents

### Amines, Alkanol Amines, and Alkyleneether Amines

Suitable amines, alkanol amines, and alkyleneether amines for use in the invention include, without limitation, any linear, branched or cyclic carbyl amine having between about 1 carbon atoms to about 40 carbon atoms. In certain embodiments, the amines are primary amines, secondary amines, tertiary amines, or mixtures or combinations thereof. The carbyl group may be any carbon containing group having between 1 and 30 carbon atoms. In certain embodiments, the carbyl groups are linear, branched, and/or cyclic alkyl groups, alkenyl groups, alkynyl groups, or mixtures and combinations thereof. In other embodiments, the carbyl groups are aryl groups, alkaryl groups, arylalkyl groups, or mixtures and combinations thereof. In other embodiments, the carbyl groups are alkanol groups, ether groups, polyether alkanol groups, or mixtures and combinations thereof. Exemplary examples include, without limitation, monocarbylamines, dicarbylamines, tricarbylamines, or mixtures and combinations thereof. Exemplary examples include, without limitation, monoalkylamine, dialkylamine, trialkylamines, monoalkanolamines, dialkanolamines, trialkanolamines, monoetheramines, dietheramines, trietheramines, cyclicamines, heterocyclic amines, alkylated analogs, alkoxylated analogs, alkylalkanolamines, dialkylalkanolamines, alkyldialkanolamines, alkyletheramines, dialkyletheramines, alkyldietheramines, alkanoletheramines, dialkanoletheramines, alkanoldietheramines, or mixtures and combinations thereof. Exemplary examples of suitable amines include, without limitation, ethoxylated amines, ethoxylated morpholine amines, alkanolamines, ethyleneamines, alkylated ethoxylated amines, alkylated ethoxylated morpholine amines, alkylated alkanolamines, alkylated ethyleneamines, alkylated amines, or mixtures and combinations thereof. The alkylating agents include, without limitation, formaldehyde, paraformaldehyde, glyoxal, other formaldehyde donors, or mixtures and combinations thereof.

In certain embodiments, the amines, alkanol amines, and alkyleneether amines suitable for this invention include alkanolamines of the general formula:

[chemical structure]

where R¹, R², and R³ are the same or different and are either a hydrogen atom (H), a linear, branched or cyclic carbyl group having between 1 and 20 carbon atoms, an R^{a}OH group, an R^{a}(OR^{aa})ₙOH group, an R^{a}OR group, an R^{a}(OR^{aa})ₙOR′ group, or mixtures and combinations thereof, provided at least one of the R¹, R², and R³ groups is not a hydrogen atom, R^{a} and R^{aa} are the same or different linear or branched carbyl linking groups having between 1 and 20 carbon atoms, and R and R′ are the same or different linear, branched or cyclic carbyl group having between 1 and 20 carbon atoms. Exemplary examples of linear, branched or cyclic carbyl linking groups include, without limitation, methylene groups, ethylene groups, propylene group, butylene groups, pentylene groups, hexylene group, higher alkylene groups, cyclopentylene group, cyclohexylene group, phenylene groups, benzylene groups, alkalated analog thereof, or mixtures and combinations thereof and the linear, branched, or cyclic carbyl groups are analogs having two attachment sites. Exemplary amines include, without limitation monoalkanol amines such as methanolamine, ethanolamine, or higher alkanol amines, dialkanolamines such as dimethanolamine, diethanolamine, N-(2-hydroxyethyl)ethylenediamine, 2-(2-(2-hydroxyetho xy)ethyl-methylamino)ethanol, b is (2-hydroxyethoxyethyl)methylamine, or mixtures and combinations thereof.

In certain embodiments, the reaction product of amines, alkanol amines, and alkyleneether amines suitable for this invention include alkanolamines of the general formula:

[chemical structure]

where R¹, R², and R³ are the same or different and are either a hydrogen atom (H), a linear, branched or cyclic carbyl group having between 1 and 20 carbon atoms, an R^{a}OH group, an R^{a}(OR^{aa})ₙOH group, an R^{a}OR group, an R^{a}(OR^{aa})ₙOR′ group, or mixtures and combinations thereof, provided at least one of the R¹, R², and R³ groups is not a hydrogen atom, R⁴ is a hydrogen atom (H), a linear, branched or cyclic carbyl group having between 1 and 20 carbon atoms and are derived from an aldehyde having the structure R⁴CHO, R^{a} and R^{aa} are the same or different linear or branched carbyl linking groups having between 1 and 20 carbon atoms, and R and R′ are the same or different linear, branched or cyclic carbyl group having between 1 and 20 carbon atoms. Exemplary examples of linear, branched or cyclic carbyl linking groups include, without limitation, methylene groups, ethylene groups, propylene group, butylene groups, pentylene groups, hexylene group, higher alkylene groups, cyclopentylene group, cyclohexylene group, phenylene groups, benzylene groups, alkylated analog thereof, or mixtures and combinations thereof and the linear, branched, or cyclic carbyl groups are analogs having two attachment sites. Exemplary amines include, without limitation, monoetheralkylamines such as methoxymethylamine, ethoxyethylamine, or higher alkoxyalkylamines, dietheralkylamines such as dimethoxyethylamine, diethoxydiethylamine, N-(2-methoxyethyl)ethylenediamine, 2-(2-(2-ethoxy)ethyl-methylamino)ethane, bis(2-ethoxyethyl)methylamine, or mixtures and combinations thereof.

Other suitable amines include, without limitation, ethyleneamines such as ethylenediamine, monoethanolamine, diethylentriamine, 2-aminoethylethanolamine, triethylenetetramine, 5-ethyl-1,4,7-triazabicyclo[4.3.0]non-4,6-diene, 5-ethyl-1,4,7-triazabicyclo [4.3.0]non-6-ene, N-(2-aminoethyl)piperazine, 4-(2-aminoethyl)diethylenetriamine, N-(2-piperazinylethyl)ethylenediamine, tetraethylenepentamine, 4-(2-aminoethyl)triethylenetetramine, pentaethylenehexamine (PEHA), hexaethyleneheptamine (HEHA), heptaethyleneoctamine (HEOA), higher molecular weight ethyleneamine and piperazine oligomers, their piperazine constituents thereof, Molex ethyleneamines such as Molex A-1328, Molex A-1320, Molex A-1303, Molex 1783L, and the corresponding alkylated ethyleneamines and hydroxylated ethyleneamines, 1,4-dimethylpiperazine, tetramethylethylenediamine, other alkylated ethyleneamines, or mixtures and combinations thereof. Other amines include, without limitation, aminocyclohexane, 1,2-diaminocyclohexane, 4-(2-aminoethyl)morpholine, propyleneamines, propylenediamines, similar amines, or mixtures and combinations thereof. In certain embodiments, the compositions of this invention include secondary alkanolamines, ethyleneamines, alkylated ethylenamines, alkylated amines, hydroxylated amine, which may be partially or totally alkylated with methyl chloride, benzyl chloride, dimethyl sulfate, diethyl sulfate, 1-chlorohexadecane, formaldehyde, paraformaldehyde, glyoxal and other alkylating agents. In other embodiments, the compositions of this invention include tertiary alkanolamines, secondary alkanolamines, partially alkylated or totally alkylated ethyleneamines, amines or mixtures and combinations thereof. Other amines include amine head's which are a combination of hexamethylenediamine, tetramethylenediamine, 3-aminopropan-1-ol, 2-methyl-1,5-pentanediamine, 2-aminocyclopentanemethylamine, and 1,2-cyclohexanediamine.

Suitable quaternizing agents for forming the A counterions include, without limitation, compounds of the general formula R⁰A including, without limitation, dialkylsulfates, where the alkyl groups are the same or different and have between 1 and 6 carbon atoms, chloroalkylbenzenes such as benzylchloride, 1,4-chloromethylbenzene, etc., where the alkyl group has between 1 and 6 carbon atoms, alkylchlorides, where the alkyl group has between 1 and 24 carbon atoms, chloroethers, where the alkyl group has between 4 and 24 carbon atoms, and alkylsulfonates, where the alkyl group is a straight chain alkyl group, or branched alkyl group, or cyclic alkyl group has between 1 to 24 carbon atoms. In all of these compounds one or more of carbon atoms may be replaced by oxygen atoms. Exemplary examples of dialkylsulfate compounds include, without limitation, dimethylsulfate, methylethylsulfate, diethylsulfate, dipropylsulfate, methylpropylsulfate, ethylpropylsulfate, higher dialkyl sulfates and mixed dialkyl sulfates, or mixtures and combinations thereof. Exemplary examples of chloroalkylbenzenes include, without limitation, benzyl chloride, chloroxylene, chloroethylbenzene, chloropropylbenzene, chlorobutylbenzene, higher chloroalkylbenzenes, or mixtures and combinations thereof. Exemplary examples of alkylchlorides include, without limitation, methyl chloride, ethyl chloride, propyl chloride, butyl chloride, pentyl chloride, hexyl chloride, heptyl chloride, octyl chloride, 1-chlorohexadecane, higher alkyl chloride, or mixtures and combinations. Exemplary examples of chloroethers include, without limitation, chloroethylethanolether, dichloroethylether, higher chlorinated ethers, or mixtures and combinations. Exemplary examples of alkylsulfonates are methylsulfonate, ethane sulfonic acid, 1-butane sulfonic acid, petroleum sulfonic acids, benzenesulfonic acid, toluene sulfonic acid, dedecylbenzene sulfonic acid, and mixtures or combination thereof.

Huntsman C-6 amine may be added to these quaternaries to raise the pH. Huntsman C-6 amine is a mixture of 2-(2-(4-morpholinyl)ethoxy)ethanol, 4-(2-(2-aminoethoxy)ethyl)morpholine, 4-(4-morpholinyl)ethoxyethyl)morpholine.

Suitable cyclic amines include, without limitation, imidazolidines, oxazolidines, piperazines, morpholines, similar higher heterocyclic amines, and mixtures or combinations thereof.

Suitable polyamines for use in the invention include, without limitation, any linear, branched, or cyclic carbyl polyamines having between about 1 carbon atoms to about 40 carbon atoms. The carbyl group may be alkanol groups, ether groups, amino groups, polyether alkanol groups, polyamine groups, or mixtures and combinations thereof. Exemplary examples include, without limitation, alkylpolyamine, alkanolpolyamines, alkylalkanolpolyamines, etherpolyamines, cyclicpolyamines, heterocyclic polyamines, alkylated analogs, alkoxylated analogs, and mixtures and combinations thereof. Exemplary examples of suitable polyamines include, without limitation, α,ω-linear or branched diamines, α,ω-alkyleneoxide diamines, α,ω-alkyleneamino diamines, or mixtures and combinations thereof. Exemplary examples of suitable polyamines include, without limitation, ethoxylated polyamines, ethoxylated morpholine polyamines, alkanol polyamines, ethylene polyamines, alkylated ethoxylated polyamines, alkylated ethoxylated morpholine polyamines, alkylated polyamines, alkylated ethylene polyamines, alkylated polyamines, or mixtures and combinations thereof. The alkylating agents include, without limitation, formaldehyde, paraformaldehyde, glyoxal, other formaldehyde donors, or mixtures and combinations thereof.

### Experiments of the Invention

Referring now to FIGS. 2-5, clay testing of prior art clay control additives are shown. Looking at FIG. 2, a plot of water release data from Weatherford Wyoming Bentonite using a 71.7 wt. % choline chloride solution is shown. Looking at FIG. 3, a plot of water release data from Weatherford Wyoming Bentonite using a 40.3 wt. % choline chloride solution is shown. Looking at FIG. 4, a plot of water release data from 1% Charles B. Chystle Co. Cream Bentonite compared to Weatherford Wyoming Bentonite for XC-197 at different GPT values is shown. Looking at FIG. 5, a plot of water release data from Weatherford Wyoming Bentonite using XC-197 is shown.

### Example 1

324.09 grams of C9 amine from Huntsman and 80.81 grams of water were added to a 1 liter resin kettle equipped with a thermocouple, thermocouple well, Vigreux distillation column, and Friedrichs column on top. C9 amine is a blend of 2-(2-(2-hydroxyethoxy)ethyl-methylamino)ethanol and bis(2-hydroxyethoxyethyl)methylamine shown pictorially in FIG. 6. The reaction mixture was agitated and heated to 190° F. 250.26 grams diethyl sulfate were added dropwise from an addition funnel over a 84 minute period, while maintaining the temperature below 215° F. The reaction mixture was held at a temperature of 200° F. for 81 minutes. The reaction mixture had a Total Amine Value (TAV) of 46.89 and a pH of 8.11. The reaction mixture was cooled to a temperature below 150° F. and 48 grams of a 31% HCl solution was added to adjust the pH to a pH of 3.09. Finally, 135 grams of water were added to the reaction mixture to yield a product having 70.0% solids and a final pH of 3.15. FIG. 7 depicts the chemical structures of the diethyl sulfate quaternary salts of C9 amines, while FIG. 8 shows a plot of water release data from Weatherford Wyoming Bentonite using the clay control additive of Example 1.

### Example 2

324.03 grams of C9 amine from Huntsman and 103.70 grams water were added to a 1 liter resin kettle equipped with a thermocouple, thermocouple well, Vigreux distillation column and Friedrichs column on top. C9 amine is a blend of 2-(2-(2-hydroxyethoxy)ethyl-methylamino)ethanol and bis(2-hydroxyethoxyethyl)methylamine shown pictorially in FIG. 6. The reaction mixtures was agitated and heated to 180° F. 204.32 grams of dimethyl sulfate was added dropwise from an addition funnel over a 56 minute period, while the temperature of the reaction mixtures was maintained 244° F. The reaction mixtures was held at a temperature between 187° F. and 207° F. for 3 hours and 53 minutes. The reaction mixture had a TAV of 31.97 and pH of 7.75. The reaction mixture was cooled to a temperature below 166° F. and 64.01 grams of 31% HCl was added the reaction mixture to adjust the pH of the reaction mixture to a pH of 2.33. 2.91 grams of Huntsman C-9 amine were then added to adjust the pH of the reaction mixture to a pH of 2.14. 97.90 grams of water was then added to the reaction product to yield a product having 69.4% solids and a final pH of 2.4. FIG. 9 depicts the chemical structures of the dimethyl sulfate quaternary salts of C9 amines, while FIG. 10 shows a plot of water release data from Weatherford Wyoming Bentonite using the clay control additive of Example 2. FIG. 11 shows a plot of water release data for the clay control additives of Example 1 and Example 2 using Cream Bentonite from Charles B. Chrystle.

### Example 3

169.66 grams diethanolamine and 221.65 grams of water were added to a liter resin kettle equipped with a thermocouple, thermocouple well, Vigreux distillation column, and Friedrichs column on top. The reaction mixture was heated to 113° F. with agitation. 64.86 grams of 37% formaldehyde in water was added dropwise to the reaction mixture over a 23 minute period. FIG. 12 shows possible amines formed in this reaction mixture. 250.43 grams diethyl sulfate was added between 100° and 204° F. in a 176 minute period. Reactor contents are a yellowish colored liquid with a pH of 2.8. 30.65 grams C6 Amine from Huntsman is added with an addition funnel to the reactor contents between 207° and 230° F. to give a black colored liquid with a final pH of 5.67 and TAV of 7.62. FIG. 13 shows chemical structures of possible diethyl sulfate quaternary salts of the reaction mixture of this example, while FIG. 14 shows a plot of water release data from Weatherford Wyoming Bentonite using the clay control additive of Example 3.

### Example 4

Add triethanolamine (351.0 grams) and water (82.8 grams) to a 1 liter resin kettle equipped with a thermocouple, thermocouple well, Vigreux distillation column and Friedrichs column on top. The reaction mixture was heated to at temperature of 153° F. with agitation. 283.68 grams of benzyl chloride were added dropwise from an addition funnel over a 182 minute period of time, while the reaction mixture was maintained at a temperature between 167° F. and 227° F. 112.15 grams of water was added to the reaction mixture to yield a product having 77.58% solids and being the form of a slight yellow transparent liquid. FIG. 15 shows a possible chemical structure of the benzyl chloride quaternary salts of triethanolamine, while FIG. 16 shows a plot of water release data from Weatherford Wyoming Bentonite using the clay control additive of Example 4.

### Example 5

319.96 grams of triethanolamine and 82.83 grams of water were added to a 1 liter resin kettle equipped with a thermocouple, thermocouple well, Vigreux distillation column, and Friedrichs column on top. The reaction mixture was heated to a temperature of 127° F. with agitation. 314.93 grams of diethyl sulfate (DES) were added dropwise from addition funnel over a 63 minute period, while the reaction mixture was maintained at a temperature below 250° F. 82.95 grams of water were added to give a product having 78.13% solids and in the form of a golden yellow transparent liquid having a TAV of 9.76 and pH of 5.95. FIG. 17 depicts the chemical structures of the diethyl sulfate quaternary salts of triethanolamine, while FIG. 18 shows a plot of water release data from Weatherford Wyoming Bentonite using the clay control additive of Example 5.

### Example 6

### Clay Stabilization Test

Clay Solution Preparation

To make 100 mL of a clay solution, measure 1 g of Cream Bentonite Clay or Weatherford Bentonite Clay material. Add 99 g of distilled water and shake bottle until all the clay is dissolved.

Blank Preparation

Measure 100 ml of clay solution in a graduated cylinder. Shake 10 times. Record separation time and clay precipitation.

Test Sample Preparation

Measure 100 mL of clay solution in a graduated cylinder and add 0.5 mL of the desired clay stabilizer. Shake 10 times. Record separation time and clay coagulation. Record clay deposition, swelling and water release. The results are tabulated in Table I.

TABLE I
Clay Stability

| | Dosage | |
|---|---|---|
| Clay Stabilizer | (wt. %/100 mL) | Final Water (mL) |
| Blank | 0 | 15% (Top) |
| Choline Chloride | 0.5 | 27 mL/60 minutes (Top) |
| Example 1 | 0.5 | 30 mL/60 minutes (Top) |
| Example 2 | 0.5 | 31 mL/60 minutes (Top) |
| Example 5 | 0.5 | 20 mL/60 minutes (Middle) |

The data in Table 1 indicates that Example 1 and Example 2 break the water out faster than choline chloride and break out more water than choline chloride.

### Example 7

Acute toxicity survival tests of Example 3, Example 4, and Example 5 and tetramethylammonium chloride (TMAC) were performed using Fathead Minnow (pimephales promelas). Because the expected toxicity of these chemical was unknown, the testing was performed in a phased approach consisting of an initial “range-finding” test, where test concentrations were progressively increased by orders of magnitude to determine a threshold toxicity range. Once the range where no minnows survived was identified, the “range-finding” test was followed by a “definitive” test, where test concentrations were progressively increased by a factor of two to determine specific toxicity ranges. As a consequence, the “definitive” test gave a more precise LC50 value. LC50 was determined using a log-normal transformation coupled with linear regression between the bracketing no observed effect concentration (NOEC) and lowest observed effect concentration (LOEC). Both the range finding and definitive tests were run on Example 4 and Example 5. Only the ranging finding test was run for TMAC and Example 3. The LC-50's are summarized in Table II.

TABLE II
Acute Toxicity Minnow Survival Test Results

| Clay Stabilizer | LC50 |
|---|---|
| tetramethylammonium chloride | 737 mg/L |
| (TMAC) | |
| Example 3 | 379 mg/L |
| Example 4 | 3160 mg/L |
| Example 5 | 6030 mg/L |

In terms of toxicity to Flathead Minnows, Example 4 and Example 5 are much less toxic than TMAC. Example 3 and TMAC exhibit similar Flathead Minnows toxicity values.

### Example 8

362 grams of ethyleneamine E-100 from Huntsman was charged to a 1 liter resin kettle equipped with a thermocouple, thermocouple well, Vigreux distillation column, and Friedrichs column on top. Ethyleneamine E-100 is a complex mixture of various linear, cyclic, and branched products with a number-average molecular weight between 250 and 300 g/mole. H₂NCH₂CH₂(NHCH₂CH₂)ₓNH₂ where (x=3, 4, 5, and higher) including tetraethylenepentamine (TEPA), pentaethylenehexamine (PEHA), hexaethyleneheptamine (HEHA), and higher molecular weight product polyamines. The reaction mixtures were agitated and heated to a temperature of 180° F. 482 grams of diethyl sulfate (DES) was added dropwise from an addition funnel over a 120 minute period of time, while the reaction mixture was maintained at a temperature below 250° F. The reaction mixture was then maintained at a temperature between 187° F. and 250° F. for 3 hours. The reaction mixture was cooled down to a temperature to 200° F., then 138 grams of water were added. The reaction mixture was cooled to keep the reaction mixture temperature below 166° F. 18 grams of 31% HCl was added to the reaction mixture to give a product having 90.31% solids, a TAV of 151 mg KOH/g and a final pH of 7.8.

### Example 9

290 grams of Amine Heads II from Ascend were charged to a 1 liter resin kettle equipped with a thermocouple, thermocouple well, Vigreux distillation column, and Friedrichs column on top. Amine Heads II is a mixture of hexamethylenediamine (HMDA), tetramethylendiamine (TMDA), 1,2 diaminocyclohexane, hexamethyleneimine (HMI). The reaction mixtures was agitated and heated to a temperature of 180° F. 710 grams diethyl sulfate (DES) was added dropwise from an addition funnel over a 120 minute period of time, while the reaction mixture was maintained at a temperature below 250° F. The reaction temperature was then maintained at a temperature between 187° F. and 250° F. for 3 hours to yield a product having 93.24% solids, a TAV of 0 mg KOH/g and a final pH of 2.4. The composition of Amine Heads II is given in Table III.

TABLE III
Amine Heads II Composition

| | | Concentration | |
|---|---|---|---|
| Components | CAS No | range | Units |
| 1,2-cyclohexanediamine | 694-83-7 | >25.0-<55.0 | % |
| hexamethylenediamine | 124-09-4 | >10.0-<30.0 | % |
| water | 7732-18-5 | >10.0-<20.0 | % |
| tetramethylenediamine | 110-60-1 | >7.0-<20.0 | % |
| 3-aminopropan-1-ol | 156-87-6 | >5.0-<15.0 | % |
| 2-aminocyclopentanemethylamine | 21544-02-5 | >1.0-<5.0 | % |
| 1,5-pentanediamine, 2-methyl | 15520-10-2 | >1.0-<5.0 | % |

### Example 10

120.02 grams; 1.15 moles of aminoethylethanolamine (AEEA) and 266.09 grams of water were added into a 1 liter resin kettle equipped with a thermocouple, thermocouple well, Vigreux distillation column, and Friedrichs column on top. The reaction mixtures was agitated and heated to a temperature of 89° F. 181.04 grams; 2.23 moles of 37% formaldehyde in water were added dropwise from an addition funnel at a rate where temperature remained below 114° F. The reaction mixtures was then heated to a temperature of 180° F. A possible reaction scheme for reactions that occurred in this example is shown in FIG. 19; while this reaction scheme is possible, the inventors are not meaning to be bound thereby. 144.7 grams; 1.14 moles of benzyl chloride were then added dropwise from an addition funnel over a 14 minute period, while the reaction mixture was maintained at a temperature between 180° F. and 212° F. The reaction mixture was in the form of an orange opaque liquid. The reaction mixture was maintained at a temperature between 180° and 204° F. for 2 hours and 58 minutes. The reaction mixture was in the form of a dark purple transparent liquid having 46.10% solids. 91.59 grams of water were then added to the reaction mixture to yield a product having 40 wt. % solids.

### Example 11

120.05 grams; 1.15 moles aminoethylethanolamine (AEEA) and 308.54 grams water were added into a 1 liter resin kettle equipped with a thermocouple, thermocouple well, Vigreux distillation column and Friedrichs column on top. TAV was 303. The reaction mixture was agitated and heated to 96° F. 187.05 grams; 2.3 moles of 37% formaldehyde in water were added dropwise from an addition funnel at a rate where temperature remained below 131° F. TAV was 194. A possible reaction scheme is shown in FIG. 19. The reaction mixture was maintained at a temperature between 128° to 131° F. for an additional 25 minutes and heated to 180° F. 82 grams; 0.57 moles dichloroethylether were added dropwise from addition funnel in 10 minutes. Reactor contents were an orange transparent liquid. The reaction mixture was maintained at a temperature between 184° F. and 229° F. for 17 hours and 49 minutes. TAV was 61.5. The reaction product was a 69.9 wt. % dark burgundy transparent liquid. 237 grams of water were added to give a solution with 40 wt. % solids. FIG. 20 depicts the chemical structures of the dichloroethylether quaternary salts of di-(3-hydroxyethylimidazolidenyl)methane. FIG. 21 shows a plot of water release data from Weatherford Wyoming Bentonite using the clay control additive of Example 11. FIG. 22 shows a plot of water release data from Weatherford Wyoming Bentonite using the clay control additive of Example 11. Bentonite.

### Example 12

120.02 grams; 1.15 moles of aminoethylethanolamine (AEEA) and 264.86 grams water were added into a 1 liter resin kettle equipped with a thermocouple, thermocouple well, Vigreux distillation column and Friedrichs column on top. The reaction mixture was agitated and heated to 97° F. 187.23 grams; 2.30 moles of 37% formaldehyde in water were added dropwise from an addition funnel at a rate in 14 minutes where the temperature remained below 140° F. The reaction scheme is shown in FIG. 19. The reaction mixtures was maintained at a temperature between 134° to 199° F. for 14 minutes. The reaction mixture was heated to 180° F. 140.20 grams; 1.10 moles of benzyl chloride were added dropwise from addition funnel in 20 minutes. The reactor contents are a red brown transparent liquid. The reaction mixtures was maintained at a temperature between 199° and 217° F. for 5 hours. TAV was 17. 67.23 grams of water were added to give a solution with 40 wt. % solids. FIG. 20 depicts the chemical structures of the benzyl chloride quaternary salts of triethanolamine. FIG. 23 shows a plot of water release data from Weatherford Wyoming Bentonite using the clay control additive of Example 12.

### Example 13A

120.13 grams; 1.15 moles aminoethylethanolamine (AEEA) and 238.95 grams water were added into a 1 liter resin kettle equipped with a thermocouple, thermocouple well, Vigreux distillation column and Friedrichs column on top. TAV was 363. The reaction mixtures was agitated and heated to 95° F. 187.60 grams; 2.30 moles of 37% formaldehyde in water were added dropwise from an addition funnel at a rate in 45 minutes, where the temperature remained below 140° F. The reactor contents are a lime green transparent liquid and had a TAV of 144. The reaction scheme is shown in FIG. 19. The reaction mixtures was maintained at a temperature between 127° to 155° F. for 30 minutes. The reaction mixture was heated to 174° F. 175.97 grams; 0.985 moles diethyl sulfate were added dropwise from addition funnel in 45 minutes. The reactor contents were a burgundy transparent liquid. The reaction mixtures was maintained at a temperature between 100° F. and 218° F. for 4 hours and 45 minutes. TAV was 24. 166 grams of water were added to give a burgundy colored solution with 39.72 wt. % solids and had a TAV of 18.34. FIG. 20 depicts the chemical structures of the diethyl sulfate quaternary salts of triethanolamine. FIG. 24 shows a plot of water release data from Weatherford Wyoming Bentonite using the clay control additive of Example 13A.

### Example 13B

200 grams Molex Amine 1328 (a mixture of aminoethylethanolamine, N-(2-aminoethyl)piperazine, 5-ethyl-1,4,7-triazabicyclo[4.3.0]non-4,6-diene, 5-ethyl-1,4,7-triazabicyclo[4.3.0]non-6-ene, triethylene tetraamine, and other polyamines) and 400 grams water were added into a 1 liter resin kettle equipped with a thermocouple, thermocouple well, Vigreux distillation column and Friedrichs column on top. The reaction mixture was heated and maintained at a temperature of 180° F. 398 grams diethyl sulfate were added dropwise from addition funnel. The reaction mixture was maintained at a temperature of 180° F. for 2 hours. The reaction product was an amber liquid with a pH of 6.7 and 59.3 wt. % solids.

### Example 14

277 grams; 0.99 moles tetrahydroxyethyl diethylenetriamine (THEDEA) and 413 grams water were added into a 1 liter resin kettle equipped with a thermocouple, thermocouple well, Vigreux distillation column and Friedrichs column on top. The reaction mixture was agitated and heated to 175° F. 310 grams; 2.01 moles of diethyl sulfate were added dropwise from addition funnel in 90 minutes. The reactor contents were a orange to red transparent liquid. The reaction mixture was maintained at a temperature between 175° F. and 200° F. for 4 hours. The final product has 56% solids and had a TAV of 9. FIG. 25 shows a plot of water release data from Weatherford Wyoming Bentonite using the clay control additive of Example 14.

### Example 15

336 g (1.45 mole) of tetrahydroxyethyl diethylenetriamine and 423 g out of 447 g total water were added to a 2 liter pressure reactor kettle. 47 g of 37% inhibited formaldehyde were added dropwise from an addition funnel. The rate of addition was adjusted to maintain reaction temperature of below 140° F. After formaldehyde addition was complete, the reaction mixture was maintained at a temperature of 130° F. for 1 hour, then the temperature was increased to 150° F. The reaction scheme is shown in FIG. 26. Charge 112 g out of 126 g (2.50 moles) total of methyl chloride in even increments over a 2 hour period, maintaining the temperature of between 175° F. and 225° F. The methyl chloride quaternary salts are shown structurally in FIG. 27. After methyl chloride addition was complete, the reaction mixture was maintained at a temperature of 200° F. for one hour. Use reserved 14 g of methyl chloride to adjust the pH of the reaction mixture to a pH below 5.5 and adjust the total amine value to below 20. Use reserved 24 g of water to adjust the reaction mixture to have a 50 wt. % solids solution. The appearance of the final product was clear to pale yellow transparent liquid. FIG. 28 shows a plot of water release data from Weatherford Wyoming Bentonite using the clay control additive of Example 15.

### Example 16

75.3 grams methanol and 407.2 grams ETHYLENEAMINE E-100 from Huntsman were added to a 1 liter resin kettle equipped with a thermocouple, thermocouple well, Vigreux distillation column and Friedrichs column on top. ETHYLENEAMINE E-100 is a mixture of tetraethylenepentamine (TEPA), pentaethylenehexamine (PEHA), hexaethyleneheptamine (HEHA), and higher molecular weight products. E-100 is a complex mixture of various linear, cyclic, and branched products with a number-average molecular weight of 250-300 g/mole. H₂NCH₂CH₂ (NHCH₂CH₂)ₓNH₂ where (x=3, 4, 5 and higher). The reaction mixture was agitated and 185 grams of formalin solution (37% Active) were added dropwise from an addition funnel, while the reaction mixture was maintained at a temperature between 130° F.-140° F. When all the formalin was added, 250 grams diethyl sulfate (DES) was added dropwise from an addition funnel over a 100 minute period of time, while the reaction mixture was maintained at a temperature below 200° F. The reaction mixture was maintained at a temperature between 187° F. and 200° F. for 2 hours. The reaction mixture was then cooled down to a temperature of 150° F. 82.5 grams of methanol was then added to yield a product having 78.52% solids, a TAV of 295 mg KOH/g and a final pH of 9.2.

### Example 17

275.2 grams Amine Heads II from Ascend were charged to a 1 liter resin kettle equipped with a thermocouple, thermocouple well, Vigreux distillation column and Friedrichs column on top. Amine Heads II is a mixture of hexamethylenediamine (HMDA), tetramethylendiamine (TMDA), 1,2-diaminocyclohexane, hexamethyleneimine (HMI). The reaction mixture was agitated and 724.8 grams diethyl sulfate were added dropwise from an addition funnel, while maintaining the temperature between 187° F. and 200° F. for 3 hours to give a product with 94.12% solids, TVA of 0 mg KOH/g and a final pH: 1.45

### Example 18

267.3 grams of 3-methoxypropylamine were added to a 1 liter resin kettle equipped with a thermocouple, thermocouple well, Vigreux distillation column, and Friedrichs column on top. The reaction mixture was agitated and 202.9 grams of formalin solution (37% Active) was added dropwise from an addition funnel, while the reaction mixture was maintained at a temperature between 130° F. and 140° F. When all the formalin was added, then 385.4 grams of diethyl sulfate (DES) were added dropwise from an addition funnel, while the reaction mixture was maintained at a temperature below 200° F. The reaction mixture was then maintained at a temperature between 187° F. and 200° F. for 2 hours. The reaction mixture was cooled down to a temperature of 150° F. 144.4 grams of water were added to give a product with 48.89% solids, a TAV of 362.70 mg KOH/g and a final pH of 11.32.

### Example 19

### Step 1

100 grams methanol and 542.9 grams of ETHYLENEAMINE E-100 from Huntsman was added to a 1 liter resin kettle equipped with a thermocouple, thermocouple well, Vigreux distillation column, and Friedrichs column on top. ETHYLENEAMINE E-100 is a mixture of tetraethylenepentamine (TEPA), pentaethylenehexamine (PEHA), hexaethyleneheptamine (HEHA), and higher molecular weight products. ETHYLENEAMINE E-100 is a complex mixture of various linear, cyclic, and branched products with a number-average molecular weight of 250-300 g/mole. H₂NCH₂CH₂ (NHCH₂CH₂)ₓNH₂ where (x=3, 4, 5 and higher). The reaction mixture was agitated and 246.7 grams of formalin solution (37% Active) were added dropwise from an addition funnel, while the reaction mixture was maintained at a temperature between 130° F. and 140° F. The reaction mixture was mixed for 1 hour and then 110.4 grams of methanol were added to yield a product having 59.62% solids, a TAV of 487 mg KOH/g and a final pH of 11.9.

### Step 2

750 grams of the product of step 1 was added to a 1 liter resin kettle equipped with a thermocouple, thermocouple well, Vigreux distillation column, and Friedrichs column on top. 250 grams of methylsulfonic acid were added dropwise from an addition funnel. The reaction mixtures was maintained at a temperature between 187° F. and 200° F. for 1 hour. The reaction mixture was cooled down to a temperature below 100° F. to yield a product having 73.37% solids, a TAV of 230 mg KOH/g and a final pH: 8.6

### Example 20

This Example compares the Linear Swell after 23 hours for Bentonite (blank), Example 9, and Comparative Example (Choline Chloride; CC-120). The lower the curve the better the Linear Swell.

The Linear Swell Meter was OFITE 115V Dynamic Linear Swell Meter Model #150-80. 14 g of Bentonite was added to a pelletizercompactor and 10,000 psi pressure was applied for 30 minutes. The pellet was removed from the compactor. Ensure all components of the Linear Swell Meter are clean: transfer stand, cap for wafer tube, bottom plate, magnetic stir bar, Teflon washer, and cup. With both the screens in the linear swell meter cell, the swell meter was zeroed out by clicking on the specific cell(s) to be zeroed out and clicked “apply”. One of the screens from the cell was removed and the pellet was added on top of the other screen. The other screen was put on top of the pellet. The transfer stand was gently placed on top of the pellet. The cell was placed on the magnetic stir plate underneath the linear variable differential transformer (LVDT) to make sure that the spindle was directly centered on top of the transfer stand. The fluid to be tested was poured through the hole on the cap for the wafer tube, the box was checked to start the cell and “apply” was clicked. Doing this will start the test for the specific cell. The test results are tabulated in Table IV.

TABLE IV
The Linear Swell after 23 hours Data

| Sample | Description | Concentration | % Swell |
|---|---|---|---|
| Blank | Bentonite | | 98.5 |
| Comparative | Choline Chloride | 6000 ppm | 88.9 |
| Example | (CC-120) | | |
| Example 9 | Amine Heads II/Et₂SO₄ | 6000 ppm | 75.9 |

Diethyl sulfate quaternary salts of Amine Head II (Example 8) swelled the clay less than choline chloride.

### Example 21

### Water Release Clay Stabilization Test

Clay Solution Preparation

To make 1 wt. % clay solution, 23 g of Wyoming Bentonite Clay and 2277 g of distilled water were added to a bottle and shaken until all the clay was dissolved.

Blank Preparation

Measure 100 mL of clay solution into a graduated cylinder. The clay solution was shaken 10 times. The clay solution separation time and clay precipitation was recorded.

Test Sample Preparation

Measure 100 mL of clay solution into 6 graduated cylinders. To each graduated cylinders was added 0.1 mL, 0.2 mL, 0.4 mL, 0.6 mL, 0.8 mL, and 1.0 mL of Examples 1-5, 8-19. The addition of the clay stabilizers at 0.1 mL, 0.2 mL, 0.4 mL, 0.6 mL, 0.8 mL, and 1.0 mL in 100 mL of a clay solution corresponds to 1, 2, 4, 6, 8 and 10 Gallons per Thousand (or gpt). Invert the cylinders 20 times. Start timer and record separation time and clay coagulation. Record clay deposition, swelling and water release. The water release volumes at 60 minutes are tabulated in Table V.

TABLE V
Water Release Clay Stabilization Test Results

| | | | | | | WR* | WR* |
|---|---|---|---|---|---|---|---|
| | WR* | WR* | WR* | WR* | WR* | 8.0 | 10.0 |
| Example | 0.5 gpt | 1.0 gpt | 2.0 gpt | 4.0 gpt | 6.0 gpt | gpt | gpt |
| TW** | n.a. | n.a. | 0 | 0 | 0 | 1 | 2 |
| 1 | n.a. | n.a. | 23 | 30 | 29 | 28 | 29 |
| 2 | n.a. | n.a. | 0 | 29 | 33 | 35 | 36 |
| 3 | n.a. | n.a. | 4 | 26 | 32 | 34 | 36 |
| 4 | n.a. | n.a. | 27 | 33 | 34 | 33 | 32 |
| 5 | n.a. | n.a. | 2 | 9 | 22 | 26 | 31 |
| 8 | 33 | 33 | 28 | 29 | 28 | 26 | 25 |
| 9 | 3 | 45 | 3 | 46 | 45 | 45 | 44 |
| 10 | n.a. | n.a. | n.a. | n.a. | n.a. | n.a. | n.a. |
| 11 | n.a. | n.a. | 1 | 11 | 28 | 26 | 26 |
| 12 | n.a. | n.a. | 0 | 10 | 14 | 14 | 14 |
| 13 | n.a. | n.a. | 0 | 0 | 30 | 33 | 33 |
| 14 | n.a. | n.a. | 27 | 32 | 31 | 30 | 30 |
| 15 | 3 | 27 | 32 | 31 | 28 | 20 | 18 |
| 16 | n.a. | n.a. | 22 | 20 | 18 | 18 | 14 |
| 17 | n.a. | n.a. | 38 | 43 | 43 | 42 | 42 |
| 18 | n.a | n.a. | 12 | 33 | 34 | 33 | 33 |
| 19 | n.a. | n.a. | 33 | 30 | 27 | 26 | 23 |

*water release at 60 minutes
**tap water

### Example 22

### Capillary Suction Timer Clay Stabilization Test

Rock Sample Preparation

A rock sample was placed in a Gyral Grinder and grinding of the rock sample was begun. The rock sample was ground for 1 hour using a timer. The ground rock sample was placed into a 200-mesh sieve. The aggregate that passed through the sieve was placed in a pan for testing and placed to the side.

Mixture Preparation

Using a 100 mL volumetric flask, a solution was prepared that will be used to mix with the rock sample. At least one solution should be prepared as the sample with straight tap water will be used as a reference blank. 100 g of solution was added to a 250 mL beaker equipped with a magnetic stir bar. A specified amount of each shale inhibitor was added to the beaker. The beaker was placed on stir plate and stirring was begun at a speed at which a vortex reaches the bottom of the beaker. 2 g of the untreated Bentonite sample was added and a timer was set for 5 minutes. After 5 minutes, the stir plate was turned off, the solution was poured into a 100 mL graduated cylinder, and a timer was set for 15 minutes. After 15 minutes, the mixture was poured back into the beaker, the beaker was placed on the magnetic stir plate and stirring was restarted on the plate. Wait until the vortex returned and the clay had become dispersed.

Test Procedure

A Venture Innovations capillary suction timer (CST) from Venture Chemicals, Inc. in Lafayette, La. was used in the tests. Before each test, the test head, filter paper, and stainless steel funnel were cleaned and dried. Make sure the cable from the test head was plugged into the control box and the reading on the control box display was reset to zero. A piece of 7×9 cm CST filter paper from Venture Innovations Inc. (part no. IFP-9053) was placed on the test head with the stainless steel probes facing down. The stainless steel funnel was fitted into the test head.

Using a 5-mL syringe, 5-mL of sample was withdrawn from the vortex. Consecutive samples were removed from the same position in the vortex, where the previous sample was taken. A 5 mL sample was charged into the stainless steel funnel. The 5 mL sample charge was repeated twice more. Instrument started automatically when a beep sounds from the control box. When this beep sounded, the timer started. After the second beep, the timer stopped and the time in seconds was displayed. The data was recorded in seconds and tabulation in Table VI.

TABLE VI
Capillary Suction Timer Clay Stabilization Test Results

| | | CST Time |
|---|---|---|
| Example | CST Concentration (ppm) | (seconds) |
| Tap Water | | 906.35 |
| 1 | 4000 | 43 |
| 2 | Not tested | Not tested |
| 3 | Not tested | Not tested |
| 4 | 4000 | 18 |
| 5 | 4000 | 90 |
| 5 | 5000 | 68 |
| 5 | 6000 | 92 |
| 8 | 4000 | 17 |
| 8 | 6000 | 17 |
| 9 | 6000 | 15 |
| 10 | 6000 | 323 |
| 11 | 6000 | 55 |
| 12 | Not tested | Not tested |
| 13 | 6000 | 38 |
| 14 | 2000 | 394 |
| 15 | 6000 | 19 |
| 16 | 6000 | 19 |
| 17 | 6000 | 15 |
| 18 | 6000 | 19 |
| 19 | 6000 | 18 |

The data clearly shows that the amine quaternary salts represent a reduced toxicity option to prior art more toxic clay control additives and stabilize the clay in a shorter period of time compared to prior art clay stabilizers.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. A clay stabilize composition comprising:
compounds of Formula (I):
[R¹R²R³N(R⁰)ⱼ]⁺A⁻ (I),
reaction products of at least one compounds of Formula (I) with at least one aldehyde of the general formula R⁴CHO, and
mixtures or combinations thereof,
where:
A and R⁰ are derived from the general formula R⁰A selected from the formulas consisting of R^{I}R^{II}SO₄, R^{I}SO₃H, R^{III}Cl, ArCl, ArR^{IV}Cl, R^{V}O(R^{VI}O)R^{VI}Cl, or mixtures and combinations thereof, where R^{I}, R^{II}, R^{III}, and R^{V} are the same or different carbyl groups, Ar is an aryl group, and R^{IV} and R^{VI} are the same or different linking carbyl groups, where R⁰ is selected from the group consisting of hydrogen atom (H), R^{I} or R^{II}, R^{III}, Ar, ArR^{IV}, R^{V}O(R^{VI}O)R^{VII}, ClR^{VI}O(R^{VI}O)R^{VI}, R^{VI}O(R^{VI}OR^{VI}, and mixtures thereof and A⁻ is selected from the group consisting of R^{I}SO₄⁻ or R^{II}SO₄⁻, R^{I}SO₃⁻, Cl⁻, [R^{VI}O(R^{VI}O)R^{VI}Cl]⁻, [R^{VI}O(R^{VI}O)R^{VI}]²⁻, and mixtures thereof, R¹, R², and R³ are the same or different and are either a hydrogen atom (H), a linear, branched or cyclic carbyl group having between 1 and 20 carbon atoms, an R^{a}OH group, an R^{a}(OR^{aa})ₙOH group, an R^{a}OR group, an R^{a}(OR^{aa})ₙOR′ group, or mixtures and combinations thereof, provided at least one of the R¹, R², and R³ groups is not a hydrogen atom,
j is an integer having a value between 1 and the maximum number of NH moieties plus 1,
R⁴ is a hydrogen atom (H), a linear, branched or cyclic carbyl group having between 1 and 20 carbon atoms,
R^{a} and R^{aa} are the same or different linear or branched carbyl linking groups having between 1 and 20 carbon atoms, and
R and R′ are linear, branched or cyclic carbyl group having between 1 and 20 carbon atoms.

2. The composition of claim 1, wherein the quaternary salts are selected from compounds of Formula (II) [chemical structure]
compounds of Formula (III): [chemical structure]
mixtures or combinations thereof.

3. The composition of claim 1, wherein the quaternary salts are selected from compounds of Formula (II):

[chemical structure]

4. The composition of claim 1, wherein the quaternary salts are selected from compounds of Formula (III):

[chemical structure]

5. The clay stabilize composition of claim 1, comprise quaternary salts of:
(a) (i) primary amines, secondary amines, and tertiary amines, (ii) monoalkanol amines, dialkanol amines, and trialkanol amines, (iii) monoalkyleneether amines, dialkyleneether amines, trialkyleneether amines, (iv) alkyl-alkanol amines, alkyl-dialkanol amines, and dialkyl-alkanol amines, (v) alkyl-alkyleneether amines, dialkyl-alkyleneether amines, and alkyl-dialkyleneether amines, (vi) alkyl-alkanol-alkyleneether amines, and (vii) alkanol-alkyleneether amines, dialkanol-alkyleneether amines, and alkanol-dialkyleneether amines;
(b) reaction products of (i) primary amines, secondary amines, and tertiary amines, (ii) monoalkanol amines, dialkanol amines, and trialkanol amines, (iii) monoalkyleneether amines, dialkyleneether amines, trialkyleneether amines, (iv) alkyl-alkanol amines, alkyl-dialkanol amines, and dialkyl-alkanol amines, (v) alkyl-alkyleneether amines, dialkyl-alkyleneether amines, and alkyl-dialkyleneether amines, (vi) alkyl-alkanol-alkyleneether amines, (vii) alkanol-alkyleneether amines, dialkanol-alkyleneether amines, and alkanol-dialkyleneether amines or (viii) mixtures and combinations thereof with an aldehyde, an aldehyde donor, or mixtures and combinations thereof; or
(c) mixtures and combinations thereof,
where the quaternizing agent comprise a compound of the general formula R⁰A selected from the formulas consisting of R^{I}R^{II}SO₄, R^{I}SO₃H, R^{III}CL, ArCl, ArR^{IV}Cl, R^{V}O(R^{VI}O)R^{VI}Cl, OR^{VI}O(R^{VI}O)R^{VI}Cl, or mixtures and combinations thereof, where R^{I}, R^{II}, R^{III}, and Rv are the same or different carbyl groups, Ar is an aryl group, and R^{IV} and R^{VI} are the same or different linking carbyl groups, where R⁰ is selected from the group consisting of hydrogen atom (H), R^{I} or R^{II}, R^{III}, Ar, ArR^{IV}, R^{V}O(R^{VI}O)R^{VII}, ClR^{VI}O(R^{VI}O)R^{VI}, R^{VI}O(R^{VI}O)R^{VI}, and mixtures thereof and A⁻ is selected from the group consisting of R^{I}SO₄⁻ or R^{II}SO₄⁻, R^{I}SO₃⁻, Cl⁻, [R^{VI}O(R^{VI}O)R^{VI}Cl]⁻, [R^{VI}O(R^{VI}O)R^{VI}]²⁻, and mixtures thereof.

6. The composition of claim 5, wherein the clay stabilize composition comprises at least one quaternary salt of (i) primary amines, secondary amines, and tertiary amines, (ii) monoalkanol amines, dialkanol amines, and trialkanol amines, (iii) monoalkyleneether amines, dialkyleneether amines, trialkyleneether amines, (iv) alkyl-alkanol amines, alkyl-dialkanol amines, and dialkyl-alkanol amines, (v) alkyl-alkyleneether amines, dialkyl-alkyleneether amines, and alkyl-dialkyleneether amines, (vi) alkyl-alkanol-alkyleneether amines, and (vii) alkanol-alkyleneether amines, dialkanol-alkyleneether amines, and alkanol-dialkyleneether amines and (viii) mixtures or combinations thereof.

7. The composition of claim 6, wherein:
the tertiary amines are a compound of the general formula: [chemical structure]
or
mixtures and combinations thereof, where n is an integer having a value between 0 and 10, and
R⁰A is selected from the group consisting of dimethyl sulfate, diethyl sulfate, benzyl chloride, methyl chloride, dichloroethylether, methane sulfonic acid, and mixtures or combinations thereof.

8. The composition of claim 7, wherein R⁰A is selected from the group consisting of diethylsulfate, dimethylsulfate, and mixtures or combinations thereof in the presence or absence of HCl.

9. The composition of claim 6, wherein the trialkanolamine is triethanolamine and R⁰A is selected from the group consisting of diethyl sulfate, dimethyl sulfate, dichloroethylether, and mixtures or combinations thereof.

10. The composition of claim 9, wherein R⁰A is diethyl sulfate.

11. The composition of claim 1, wherein the quaternary salts further comprise a mixture of 1,2-cyclohexanediamine, hexamethylenediamine, tetramethylenediamine, 3-aminopropan-1-ol, 2-aminocyclopentanemethylamine and 2-methyl-1,5,pentanediamine and R⁰A is selected from the group consisting of dimethylsulfate, diethylsulfate, benzylchloride, methylchloride, dichloroethylether, and mixtures or combinations thereof.

12. The composition of claim 11, wherein R⁰A is with diethyl sulfate.

13. The composition of claim 1, further comprising a corrosion system including a mixture of 2-(2-(4-morpholinyl)ethoxy)ethanol, 4-(2-2-aminoethoxy)ethyl)morpholine, and 4-(4-morpholinyl)ethoxyethyl)morpholine.

14. The composition of claim 1, wherein the clay stabilize composition comprises at least one quaternary salt of a reaction product.

15. The composition of claim 14 wherein the reaction products comprise reactions of:
amines of the general formula:
R¹¹R¹²NH
and formaldehyde or a formaldehyde donor,
where R¹¹ and R¹² is a hydrogen atom, a linear, branched, or cyclic carbyl group having between 1 and 20 carbon atoms, provided that both R¹¹ and R¹² are not a hydrogen atom and R⁰A is selected from the group consisting of methyl chloride, benzyl chloride, dimethylsulfate, diethylsulfate, dichloroethylether, and mixtures or combinations thereof.

16. The composition of 15, further comprising a corrosion system including a mixture of 2-(2-(4-morpholinyl)ethoxy)ethanol, 4-(2-2-aminoethoxy)ethyl)morpholine, and 4-(4-morpholinyl)ethoxyethyl) morpholine

17. The composition of claim 15, wherein R¹¹ is hydrogen and R¹² is a linear, branched or cyclic carbyl group having between 1 and 20 carbon atoms.

18. The composition of claim 15, wherein the amines are given by the general formula:
H₃CO(CH₂)ₙNH₂
where n is an integer having a value between 1 to 10.

19. The composition of claim 15, where the amine comprises H₃CO(CH₂)₃NH₂.

20. The composition of claim 15, wherein the dialkanolamine comprises HN(CH₂CH₂OH)₂.

21. The composition claims of 15-20, further comprising a corrosion system including a mixture of 2-(2-(4-morpholinyl)ethoxy)ethanol, 4-(2-2-aminoethoxy)ethyl)morpholine, and 4-(4-morpholinyl)ethoxyethyl)morpholine

22. A method for stabilizing clay during drilling comprising:
drilling into a clay containing formation with a drilling fluid including an effective amount of a clay stabilize composition comprising compounds of Formula (I):
[R¹R²R³N(R⁰)ⱼ]⁺A⁻ (I)
and reaction products of at least one compounds of Formula (I) with at least one aldehyde of the general formula R⁴CHO,
where:
A and R⁰ are derived from the general formula R⁰A selected from the formulas consisting of R^{I}R^{II}SO₄, R^{I}SO₃H, R^{III}Cl, ArCl, ArR^{IV}Cl, R^{V}O(R^{VI}O)R^{VI}Cl, ClR^{VI}O(R^{VI}O)R^{VI}Cl, or mixtures and combinations thereof, where R^{I}, R^{II}, R^{III}, and R^{V} are the same or different carbyl groups, Ar is an aryl group, and R^{IV} and R^{VI} are the same or different linking carbyl groups, where R⁰ is selected from the group consisting of hydrogen atom (H), R^{I} or R^{II}, R^{III}, Ar, ArR^{IV}, R^{V}O(R^{VI}O)R^{VII}, ClR^{VI}O(R^{VI}O)R^{VI}, R^{VI}O(R^{VI}O)R^{VI}, and mixtures thereof and A⁻ is selected from the group consisting of R^{I}SO₄⁻ or R^{II}SO₄⁻, R^{I}SO₃⁻, Cl⁻, [R^{VI}O(R^{VI}O)R^{VI}Cl]⁻, [R^{VI}O(R^{VI}O)R^{VI}]²⁻, and mixtures thereof,
R¹, R², and R³ are the same or different and are either a hydrogen atom (H), a linear, branched or cyclic carbyl group having between 1 and 20 carbon atoms, an R^{a}OH group, an R^{a}(OR^{aa})ₙOH group, an R^{a}OR group, an R^{a}(OR^{aa})ₙOR′ group, or mixtures and combinations thereof, provided at least one of the R¹, R², and R³ groups is not a hydrogen atom,
j is an integer having a value between 1 and the maximum number of NH moieties plus 1,
R⁴ is a hydrogen atom (H), a linear, branched or cyclic carbyl group having between 1 and 20 carbon atoms,
R^{a} and R^{aa} are the same or different linear or branched carbyl linking groups having between 1 and 20 carbon atoms, and
R and R′ are linear, branched or cyclic carbyl group having between 1 and 20 carbon atoms.

23. The method of claim 22, wherein the quaternary salts are selected from compounds of Formula (II) [chemical structure]
compounds of Formula (III): [chemical structure]
and mixtures or combinations thereof.

24. The method of claim 22, wherein the quaternary salts are selected from compounds of Formula (II):

[chemical structure]

25. The method of claim 22, wherein the quaternary salts are selected from compounds of Formula (III):

[chemical structure]

26. The method of claim 1, comprise quaternary salts of:
(a) (i) primary amines, secondary amines, and tertiary amines, (ii) monoalkanol amines, dialkanol amines, and trialkanol amines, (iii) monoalkyleneether amines, dialkyleneether amines, trialkyleneether amines, (iv) alkyl-alkanol amines, alkyl-dialkanol amines, and dialkyl-alkanol amines, (v) alkyl-alkyleneether amines, dialkyl-alkyleneether amines, and alkyl-dialkyleneether amines, (vi) alkyl-alkanol-alkyleneether amines, and (vii) alkanol-alkyleneether amines, dialkanol-alkyleneether amines, and alkanol-dialkyleneether amines;
(b) reaction products of (i) primary amines, secondary amines, and tertiary amines, (ii) monoalkanol amines, dialkanol amines, and trialkanol amines, (iii) monoalkyleneether amines, dialkyleneether amines, trialkyleneether amines, (iv) alkyl-alkanol amines, alkyl-dialkanol amines, and dialkyl-alkanol amines, (v) alkyl-alkyleneether amines, dialkyl-alkyleneether amines, and alkyl-dialkyleneether amines, (vi) alkyl-alkanol-alkyleneether amines, (vii) alkanol-alkyleneether amines, dialkanol-alkyleneether amines, and alkanol-dialkyleneether amines or (viii) mixtures and combinations thereof with an aldehyde, an aldehyde donor, or mixtures and combinations thereof; or
(c) mixtures and combinations thereof,
where the quaternizing agent comprise a compound of the general formula R⁰A selected from the formulas consisting of R^{I}R^{II}SO₄, R^{I}SO₃H, R^{III}Cl, ArCl, ArR^{IV}Cl, R^{V}O(R^{VI}O)R^{VI}Cl, ClR^{VI}O(R^{V}O)R^{VI}Cl, or mixtures and combinations thereof, where a hydrogen atom (H), R^{I}, R^{II}, R^{III}, and R^{V} are the same or different carbyl groups, Ar is an aryl group, and R^{IV} and R^{VI} are the same or different linking carbyl groups, where R⁰ is selected from the group consisting of hydrogen atom (H), R^{I} or R^{II}, R^{III}, Ar, ArR^{IV}, R^{V}O(R^{VI}O)R^{VII}, ClR^{VI}O(R^{VI}O)R^{VI}, R^{VI}O(R^{VI}O)R^{VI}, and mixtures thereof and A⁻ is selected from the group consisting of R^{I}SO₄⁻ or R^{II}SO₄⁻, R^{I}SO₃⁻, Cl⁻, [R^{VI}O(R^{VI}O)R^{VI}Cl]⁻, [R^{VI}O(R^{VI}O)R^{VI}]²⁻, and mixtures thereof.

27. The method of claim 26, wherein the clay stabilize composition comprises at least one quaternary salt of (i) primary amines, secondary amines, and tertiary amines, (ii) monoalkanol amines, dialkanol amines, and trialkanol amines, (iii) monoalkyleneether amines, dialkyleneether amines, trialkyleneether amines, (iv) alkyl-alkanol amines, alkyl-dialkanol amines, and dialkyl-alkanol amines, (v) alkyl-alkyleneether amines, dialkyl-alkyleneether amines, and alkyl-dialkyleneether amines, (vi) alkyl-alkanol-alkyleneether amines, and (vii) alkanol-alkyleneether amines, dialkanol-alkyleneether amines, and alkanol-dialkyleneether amines and (viii) mixtures or combinations thereof.

28. The method of claim 27, wherein:
the tertiary amines are a compound of the general formula: [chemical structure]
or
mixtures and combinations thereof, where n is an integer having a value between 0 and 10, and
R⁰A is selected from the group consisting of dimethyl sulfate, diethyl sulfate, benzyl chloride, methyl chloride, dichloroethylether, and mixtures or combinations thereof.

29. The method of claim 28, wherein R⁰A is selected from the group consisting of diethylsulfate, dimethylsulfate, and mixtures or combinations thereof in the presence or absence of HCl.

30. The method of claim 27, wherein the trialkanolamine is triethanolamine and R⁰A is selected from the group consisting of diethyl sulfate, dimethyl sulfate, dichloroethylether, and mixtures or combinations thereof.

31. The method of claim 30, wherein R⁰A is diethyl sulfate.

32. The method of claim 22, wherein the quaternary salts further comprise a mixture of 1,2-cyclohexanediamine, hexamethylenediamine, tetramethylenediamine, 3-aminopropan-1-ol, 2-aminocyclopentanemethylamine and 2-methyl-1,5,pentanediamine and R⁰A is selected from the group consisting of dimethylsulfate, diethylsulfate, benzylchloride, methylchloride, dichloroethylether, and mixtures or combinations thereof.

33. The method of claim 32, wherein R⁰A is with diethyl sulfate.

34. The method of claim 22, wherein the clay stabilizing compositions further includes a corrosion system includes a mixture of 2-(2-(4-morpholinyl)ethoxy)ethanol, 4-(2-2-aminoethoxy)ethyl)morpholine, and 4-(4-morpholinyl)ethoxyethyl)morpholine.

35. The method of claim 22, wherein the clay stabilize composition comprises at least one quaternary salt of a reaction product.

36. The method of claim 35, wherein the reaction products comprise reactions of:
amines of the general formula:
R¹¹R¹²NH
and formaldehyde or a formaldehyde donor,
where R¹¹ and R¹² is a hydrogen atom, a linear, branched, or cyclic carbyl group having between 1 and 20 carbon atoms, provided that both R¹¹ and R¹² are not a hydrogen atom and R⁰A is selected from the group consisting of methyl chloride, benzyl chloride, dimethylsulfate, diethylsulfate, dichloroethylether, and mixtures or combinations thereof.

37. The method of 36, wherein the clay stabilizing compositions further includes a corrosion system includes a mixture of 2-(2-(4-morpholinyl)ethoxy)ethanol, 4-(2-2-aminoethoxy)ethyl)morpholine, and 4-(4-morpholinyl)ethoxyethyl)morpholine

38. The method of claim 36, wherein R¹¹ is hydrogen and R¹² is a linear, branched or cyclic carbyl group having between 1 and 20 carbon atoms.

39. The method of claim 36, wherein the amines are given by the general formula:
H₃CO(CH₂)ₙNH₂
where n is an integer having a value between 1 to 10.

40. The method of claim 36, where the amine comprises H₃CO(CH2)₃NH₂.

41. The method of claim 36, wherein the dialkanolamine comprises HN(CH₂CH₂OH)₂.

42. The method claims of 36-41, wherein the clay stabilizing compositions further includes a corrosion system includes a mixture of 2-(2-(4-morpholinyl)ethoxy)ethanol, 4-(2-2-aminoethoxy)ethyl)morpholine, and 4-(4-morpholinyl)ethoxyethyl)morpholine.

43. A method for stabilizing clay during production comprising:
pumping into a clay containing formation with a completion fluid including an effective amount of a clay stabilize composition comprising compounds of Formula (I):
[R¹R²R³N(R⁰)ⱼ]⁺A⁻ (I)
and reaction products of at least one compounds of Formula (I) with at least one aldehyde of the general formula R⁴CHO,
where:
A and R⁰ are derived from the general formula R⁰A selected from the formulas consisting of R^{I}R^{II}SO₄, R^{I}SO₃H, R^{III}Cl, ArCl, ArR^{IV}Cl, R^{V}O(R^{VI}O)R^{VI}Cl, ClR^{VI}O(R^{VI}O)R^{VI}Cl, or mixtures and combinations thereof, where R^{I}, R^{II}, R^{III}, and R^{V} are the same or different carbyl groups, Ar is an aryl group, and R^{IV} and R^{VI} are the same or different linking carbyl groups, where R⁰ is selected from the group consisting of hydrogen atom (H), R^{I} or R^{II}, R^{III}, Ar, ArR^{IV}, R^{V}O(R^{VI}O)R^{VII}, ClR^{VI}O(R^{VI}O)R^{VI}, R^{VI}O(R^{VI}O)R^{VI}, and mixtures thereof and A⁻ is selected from the group consisting of R^{I}SO₄⁻ or R^{II}SO₄⁻, R^{I}SO₃⁻, Cl⁻, [R^{VI}O(R^{VI}O)R^{VI}Cl]⁻, [R^{VI}O(R^{VI}O)R^{VI}]²⁻, and mixtures thereof,
R¹, R², and R³ are the same or different and are either a hydrogen atom (H), a linear, branched or cyclic carbyl group having between 1 and 20 carbon atoms, an R^{a}OH group, an R^{a}(OR^{aa})ₙOH group, an R^{a}OR group, an R^{a}(OR^{aa})ₙOR′ group, or mixtures and combinations thereof, provided at least one of the R¹, R², and R³ groups is not a hydrogen atom,
j is an integer having a value between 1 and the maximum number of NH moieties plus 1,
R⁴ is a hydrogen atom (H), a linear, branched or cyclic carbyl group having between 1 and 20 carbon atoms,
R^{a} and R^{aa} are the same or different linear or branched carbyl linking groups having between 1 and 20 carbon atoms, and
R and R′ are linear, branched or cyclic carbyl group having between 1 and 20 carbon atoms.

44. The method of claim 43, wherein the quaternary salts are selected from compounds of Formula (II) [chemical structure]
compounds of Formula (III): [chemical structure]
and mixtures or combinations thereof.

45. The method of claim 43, wherein the quaternary salts are selected from compounds of Formula (II):

[chemical structure]

46. The method of claim 43, wherein the quaternary salts are selected from compounds of Formula (III):

[chemical structure]

47. The method of claim 43, comprise quaternary salts of:
(a) (i) primary amines, secondary amines, and tertiary amines, (ii) monoalkanol amines, dialkanol amines, and trialkanol amines, (iii) monoalkyleneether amines, dialkyleneether amines, trialkyleneether amines, (iv) alkyl-alkanol amines, alkyl-dialkanol amines, and dialkyl-alkanol amines, (v) alkyl-alkyleneether amines, dialkyl-alkyleneether amines, and alkyl-dialkyleneether amines, (vi) alkyl-alkanol-alkyleneether amines, and (vii) alkanol-alkyleneether amines, dialkanol-alkyleneether amines, and alkanol-dialkyleneether amines;
(b) reaction products of (i) primary amines, secondary amines, and tertiary amines, (ii) monoalkanol amines, dialkanol amines, and trialkanol amines, (iii) monoalkyleneether amines, dialkyleneether amines, trialkyleneether amines, (iv) alkyl-alkanol amines, alkyl-dialkanol amines, and dialkyl-alkanol amines, (v) alkyl-alkyleneether amines, dialkyl-alkyleneether amines, and alkyl-dialkyleneether amines, (vi) alkyl-alkanol-alkyleneether amines, (vii) alkanol-alkyleneether amines, dialkanol-alkyleneether amines, and alkanol-dialkyleneether amines or (viii) mixtures and combinations thereof with an aldehyde, an aldehyde donor, or mixtures and combinations thereof; or
(c) mixtures and combinations thereof,
where the quaternizing agent comprise a compound of the general formula R⁰A selected from the formulas consisting of R^{I}R^{II}SO₄, R^{I}SO₃H, R^{III}Cl, ArCl, ArR^{IV}Cl, R^{V}O(R^{VI}O)R^{VI}Cl, OR^{VI}O(R^{VI}O)R^{VI}Cl, or mixtures and combinations thereof, where R^{I}, R^{II}, R^{III}, and R^{V} are the same or different carbyl groups, Ar is an aryl group, and R^{IV} and R^{VI} are the same or different linking carbyl groups, where R⁰ is selected from the group consisting of hydrogen atom (H), R^{I} or R^{II}, R^{III}, Ar, ArR^{IV}, R^{V}O(R^{VI}O)R^{VII}, ClR^{VI}O(R^{VI}O)R^{VI}, R^{VI}O(R^{VI}O)R^{VI}, and mixtures thereof and A⁻ is selected from the group consisting of R^{I}SO₄⁻ or R^{II}SO₄⁻, R^{I}SO₃⁻, Cl⁻, [R^{VI}O)(R^{VI}O)R^{VI}Cl]⁻, [R^{VI}O(R^{VI}O)R^{VI}]²⁻, and mixtures thereof.

48. The method of claim 47, wherein the clay stabilize composition comprises at least one quaternary salt of (i) primary amines, secondary amines, and tertiary amines, (ii) monoalkanol amines, dialkanol amines, and trialkanol amines, (iii) monoalkyleneether amines, dialkyleneether amines, trialkyleneether amines, (iv) alkyl-alkanol amines, alkyl-dialkanol amines, and dialkyl-alkanol amines, (v) alkyl-alkyleneether amines, dialkyl-alkyleneether amines, and alkyl-dialkyleneether amines, (vi) alkyl-alkanol-alkyleneether amines, and (vii) alkanol-alkyleneether amines, dialkanol-alkyleneether amines, and alkanol-dialkyleneether amines and (viii) mixtures or combinations thereof.

49. The method of claim 48, wherein:
the tertiary amines are a compound of the general formula: [chemical structure]
or
mixtures and combinations thereof, where n is an integer having a value between 0 and 10, and
R⁰A is selected from the group consisting of dimethyl sulfate, diethyl sulfate, benzyl chloride, methyl chloride, dichloroethylether, and mixtures or combinations thereof.

50. The method of claim 49, wherein R⁰A is selected from the group consisting of diethylsulfate, dimethylsulfate, and mixtures or combinations thereof in the presence or absence of HCl.

51. The method of claim 48, wherein the trialkanolamine is triethanolamine and R⁰A is selected from the group consisting of diethyl sulfate, dimethyl sulfate, dichloroethylether, and mixtures or combinations thereof.

52. The method of claim 51, wherein R⁰A is diethyl sulfate.

53. The method of claim 43, wherein the quaternary salts further comprise a mixture of 1,2-cyclohexanediamine, hexamethylenediamine, tetramethylenediamine, 3-aminopropan-1-ol, 2-aminocyclopentanemethylamine and 2-methyl-1,5,pentanediamine and R⁰A is selected from the group consisting of dimethylsulfate, diethylsulfate, benzylchloride, methylchloride, dichloroethylether, and mixtures or combinations thereof.

54. The method of claim 53, wherein R⁰A is with diethyl sulfate.

55. The method of claim 43, wherein the clay stabilizing compositions further includes a corrosion system includes a mixture of 2-(2-(4-morpholinyl)ethoxy)ethanol, 4-(2-2-aminoethoxy)ethyl)morpholine, and 4-(4-morpholinyl)ethoxyethyl)morpholine.

56. The method of claim 43, wherein the clay stabilize composition comprises at least one quaternary salt of a reaction product.

57. The method of claim 56, wherein the reaction products comprise reactions of:
amines of the general formula:
R¹¹R¹²NH
and formaldehyde or a formaldehyde donor,
where R¹¹ and R¹² is a hydrogen atom, a linear, branched, or cyclic carbyl group having between 1 and 20 carbon atoms, provided that both R¹¹ and R¹² are not a hydrogen atom and R⁰A is selected from the group consisting of methyl chloride, benzyl chloride, dimethylsulfate, diethylsulfate, dichloroethylether, and mixtures or combinations thereof.

58. The method of 57, wherein the clay stabilizing compositions further includes a corrosion system includes a mixture of 2-(2-(4-morpholinyl)ethoxy)ethanol, 4-(2-2-aminoethoxy)ethyl)morpholine, and 4-(4-morpholinyl)ethoxyethyl)morpholine

59. The method of claim 57, wherein R¹¹ is hydrogen and R¹² is a linear, branched or cyclic carbyl group having between 1 and 20 carbon atoms.

60. The method of claim 57, wherein the amines are given by the general formula:
H₃CO(CH₂)ₙNH₂
where n is an integer having a value between 1 to 10.

61. The method of claim 57, where the amine comprises H₃CO(CH₂)₃NH₂.

62. The method of claim 57, wherein the dialkanolamine comprises HN(CH₂CH₂OH)₂.

63. The composition claims of 47-62, wherein the clay stabilizing compositions further includes a corrosion system includes a mixture of 2-(2-(4-morpholinyl)ethoxy)ethanol, 4-(2-2-aminoethoxy)ethyl)morpholine, and 4-(4-morpholinyl)ethoxyethyl)morpholine.
